(19) United States
(12) Patent Application Publication
(10) Pub. No.: US 2025/0013309 A1
(43) Pub. Date: Jan. 9, 2025

(54) VIRTUAL OBJECT DISPLAY METHOD AND APPARATUS, ELECTRONIC DEVICE AND READABLE MEDIUM

(71) Applicant: Beijing Bytedance Network Technology Co., Ltd., Shijingshan District, Beijing (CN)

(72) Inventors: Qingwen Hu, Beijing (CN); Hang Zhao, Beijing (CN); Gaojie Lin, Beijing (CN); Dengke Dong, Beijing (CN)

(21) Appl. No.: 18/707,033

(22) PCT Filed: Nov. 2, 2022
(86) PCT No.: PCT/CN2022/129120

§ 371 Date: May 2, 2024

(30) Foreign Application Priority Data
Nov. 4, 2021 (CN) 202111300823.2

(51) Int. Cl. G06F 3/01; G06T 7/20; G06T 7/70; G06V 40/20

(52) U.S. Cl. CPC G06F 3/017; G06T 7/20; G06T 7/70; G06V 40/28

(57) ABSTRACT

Disclosed are a virtual object display method and apparatus, an electronic device, and a readable medium. The method comprises: recognizing a trigger gesture from hand images according to three-dimensional coordinates of a hand key point, the hand images comprising at least two continuous frames of first hand images in which the hand key point is relatively stationary, at least one frame of a second hand image in which the hand key point moving relative to the first hand image, and a gesture of at least one of the first hand images and the second hand image being the trigger gesture; in response to the trigger gesture, determining a throwing parameter according to the hand images; simulating a trajectory of a thrown virtual object according to the throwing parameter and displaying the trajectory in an augmented reality scene.

### CROSS-REFERENCE TO RELATED APPLICATION(S)

This application claims priority to Chinese Application No. 202111300823.2, filed in the China Patent Office on Nov. 4, 2021, and the disclosure of which is incorporated herein by reference in its entity.

### FIELD

Embodiments of the present disclosure relate to the technical field of augmented reality, for example, to a virtual object display method and apparatus, an electronic device and a readable medium.

### BACKGROUND

Augmented Reality (AR) is a technology that fuses virtual information with a real world. Based on the AR technology, a virtual object is displayed in the picture of a photographed real scenario in a superposition manner, and a user may control the virtual object by means of different actions, so that the virtual object moves in the picture of the real scenario, and on this basis, some interesting games or multi-person interaction applications and the like may be designed, for example, a virtual object such as a basketball is thrown in an AR scenario, so as to enhance the authenticity and interestingness of a throwing operation.

In general, the actions of the user are complex and diversified, and some actions unrelated to the control over the virtual object may be recognized as specific throwing operations, thus affecting the accuracy of simulating and displaying the motion trajectory of the virtual object. For example, during the process of throwing the basketball in the AR scenario, the user needs to put the hand within a range that may be captured by a camera and make different actions to control the movement of the basketball, all the actions of the hand during the process may be recognized as throwing actions, such that the motion trajectory of the basketball does not conform to the actions of the user, thus affecting the user experience.

### SUMMARY

The present disclosure provides a virtual object display method and apparatus, an electronic device and a readable medium, so as to improve the accuracy of simulating and displaying the motion trajectory of a virtual object.

In a first aspect, an embodiment of the present disclosure provides a virtual object display method, including:
recognizing, according to three-dimensional coordinates of a hand key point, a trigger gesture of throwing a virtual object from hand images, wherein the hand images include at least two consecutive frames of first hand images in which the hand key point is relatively stationary, at least one frame of second hand image in which the hand key point moves relative to the first hand images, and a gesture in at least one of the first hand images and the second hand image is the trigger gesture;
in response to the trigger gesture, determining a throwing parameter according to the hand images; and
simulating a motion trajectory to throw the virtual object according to the throwing parameter, and displaying the virtual object in an AR scenario according to the motion trajectory.

In a second aspect, an embodiment of the present disclosure further provides a virtual object display apparatus, including:
a gesture recognition module, configured to: recognize, according to three-dimensional coordinates of a hand key point, a trigger gesture of throwing a virtual object from hand images, wherein the hand images include at least two consecutive frames of first hand images in which the hand key point is relatively stationary, at least one frame of second hand image in which the hand key point moves relative to the first hand images, and a gesture in at least one of the first hand images and the second hand image is the trigger gesture;
a parameter determination module, configured to: in response to the trigger gesture, determine a throwing parameter according to the hand images; and
a simulation and display module, configured to: simulate a motion trajectory to throw the virtual object according to the throwing parameter, and display the virtual object in an AR scenario according to the motion trajectory.

In a third aspect, an embodiment of the present disclosure further provides an electronic device, including:
one or more processors; and
a storage, configured to store one or more programs, wherein,
when the one or more programs are executed by the one or more processors, the one or more processors implement the virtual object display method in the first aspect.

In a fourth aspect, an embodiment of the present disclosure further provides a computer-readable medium, on which a computer program is stored, wherein the program, when being executed by a processor, implements the virtual object display method in the first aspect.

### BRIEF DESCRIPTION OF THE DRAWINGS

Throughout the drawings, the same or similar reference signs represent the same or similar elements. It should be understood that the drawings are schematic, and components and elements are not necessarily drawn to scale.

FIG. 1 is a flowchart of a virtual object display method provided in an embodiment of the present disclosure;

FIG. 2 is a schematic diagram of throwing a virtual object in an AR scenario provided in an embodiment of the present disclosure;

FIG. 3 is a flowchart of a virtual object display method provided in another embodiment of the present disclosure;

FIG. 4 is a flowchart of a virtual object display method provided in another embodiment of the present disclosure;

FIG. 5 is a flowchart of a virtual object display method provided in another embodiment of the present disclosure;

FIG. 6 is a schematic structural diagram of a virtual object display apparatus provided in an embodiment of the present disclosure; and

FIG. 7 is a schematic diagram of a hardware structure of an electronic device provided in an embodiment of the present disclosure.

### DETAILED DESCRIPTION OF EMBODIMENTS

It should be understood that a plurality of steps recorded in method embodiments of the present disclosure may be executed in different sequences and/or in parallel. In addition, the method embodiments may include additional steps and/or omit executing the steps shown. The scope of the present disclosure is not limited in this respect.

As used herein, the terms “include” and variations thereof are open-ended terms, i.e., “including, but not limited to”. The term “based on” is “based, at least in part, on”. The term “one embodiment” means “at least one embodiment”; the term “another embodiment” means “at least one additional embodiment”; and the term “some embodiments” means “at least some embodiments”. Relevant definitions of other terms will be given in the following description.

It should be noted that concepts such as “first” and “second” mentioned in the present disclosure are only intended to distinguish different apparatuses, modules or units, and are not intended to limit the sequence or interdependence of the functions executed by these apparatuses, modules or units.

The names of messages or information interacted between a plurality of apparatuses in the embodiments of the present disclosure are for illustrative purposes only and are not intended to limit the scope of these messages or information.

In a plurality of embodiments below, example features and examples are provided in each embodiment at the same time, and a plurality of features recorded in the embodiments may be combined to form a plurality of example solutions, and the embodiment of each serial number should not be considered as only one technical solution. In addition, in the case of no conflict, the embodiments in the present disclosure and the features in the embodiments may be combined with each other.

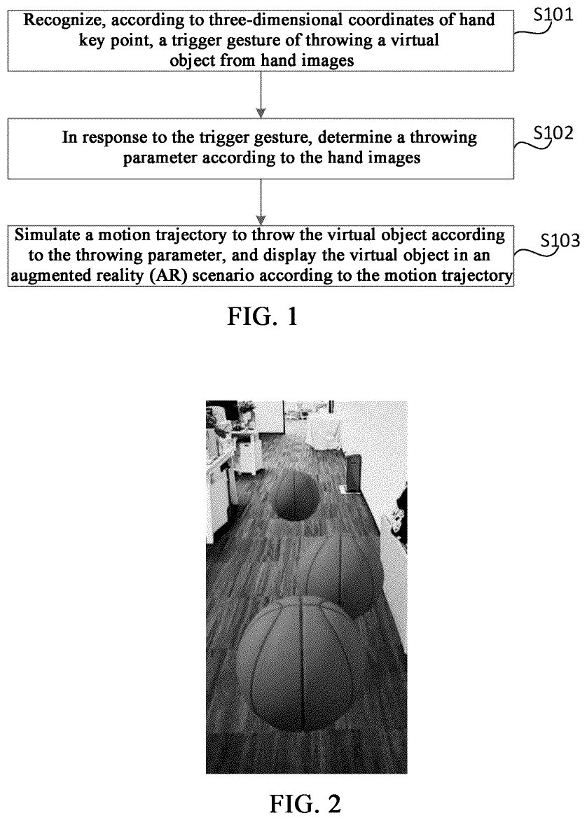

FIG. 1 is a schematic flowchart of a virtual object display method provided in an embodiment of the present disclosure. The method may be applicable to the case where a thrown virtual object is displayed in an AR scenario. For example, the motion trajectory of the virtual object is simulated by means of recognizing a gesture from a hand image, and the virtual object is displayed in the AR scenario according to the motion trajectory, so as to implement virtual-real combination. The method may be executed by a virtual object display apparatus, wherein the apparatus may be implemented by software and/or hardware, and is integrated on an electronic device. The electronic device in the present embodiment may be a device having an image processing function, such as a computer, a notebook computer, a server, a tablet computer, or a smart phone.

As shown in FIG. 1, the virtual object display method provided in the embodiment of the present disclosure includes the following steps:

S110, according to three-dimensional coordinates of a hand key point, recognizing a trigger gesture of throwing a virtual object from hand images.

In the present embodiment, the hand image mainly refers to an image containing a hand of a user, and may be collected by the electronic device via an image sensor (e.g., a camera, a vidicon, etc.). There are plurality of frames of hand images, each frame contains a hand area of the user, and a pose of the hand may be recognized according to the hand key point, so as to determine whether the hand images contains the trigger gesture. The hand key point is, for example, a fingertip of one or more fingers, a joint point, a plurality of phalanx joints, etc.

The trigger gesture mainly refers to a pose presented by the hand when it is determined that the intention of the user is to throw the virtual object. For example, a palm is curved in an arc shape, presents a pose that may hold the virtual object and the like, and moves towards a throwing destination position in several consecutive frames. If the pose of the hand in a plurality of consecutive frames of hand images change from stationary to moving and all conform to the gesture of throwing the virtual object, it is recognized that the gesture is trigger gesture, and in this case, the movement conditions of the hand in the plurality of frames of hand images may be analyzed to analyze a throwing parameter of the user for the virtual object, so as to control the virtual object.

In the present embodiment, the hand images include at least two consecutive frames of first hand images in which the hand key point is relatively stationary, at least one frame of second hand image in which the hand key point moves relative to the first hand images, and a gesture in the first hand images and/or the second hand image is the trigger gesture.

For example, the trigger gesture may be recognized in combination with at least three consecutive frames of hand images, wherein the hand key point in at least two previous frames of hand images are relatively stationary, that is, the hand do not move in the at least two previous frames of hand images; and the hand key point in at least one subsequent frame of hand image generate relative movement, that is, before it is determined that the intention of the user is to throw the virtual object, the hand pause in at least two frames to prepare for throwing, if the hand move, it may be regarded as that the hand generate forces, and in this case, a throwing operation for the virtual object is triggered.

S120, in response to the trigger gesture, determining a throwing parameter according to the hand images.

In the present embodiment, after the trigger gesture is recognized, the throwing operation for the virtual object is triggered, and the throwing parameter of the hand to the virtual object is determined according to the hand images. The throwing parameter includes a parameter affecting the motion trajectory of the virtual object, for example, a moving speed of the hand, a throwing position, a throwing force, and/or a throwing direction, etc. The throwing parameter is determined according to the hand images, wherein the moving speed of the hand may be determined according to the displacements of the hand key point in the second hand image and a collection interval of the hand images, and the throwing position may be determined according to the three-dimensional coordinates of the hand key point, for example, the position of the hand key point in a certain frame of hand image, which generates relative moment, is used as the throwing position; the throwing force may be determined according to the magnitude of the speed and/or the acceleration of the relative movement of the hand in several consecutive frames of hand images; and the throwing direction may be determined according to the direction of the speed and/or the acceleration of the relative movement of the hand in several consecutive frames of hand images.

S130, simulating a motion trajectory to throw the virtual object according to the throwing parameter, and displaying the virtual object in an AR scenario according to the motion trajectory.

In the present embodiment, by means of constructing the AR scenario and combining a real-world picture captured by an electronic device, the virtual object is loaded into the AR scenario, wherein the virtual object is, for example, a basketball. In addition, objects associated with the throwing of the virtual object, such as a basket, a basket net, a backboard, and the like, may also be added, and the positions of these objects in the AR scenario are fixed. Based on determining the throwing parameter, a physical motion model of the virtual object may also be established in combination with the weight, gravity, air resistance and the like of the virtual object, so as to simulate the motion trajectory of the virtual object. For example, the motion trajectory is roughly a parabola starting from the throwing position, and the virtual object is displayed in the AR scenario according to the motion trajectory.

FIG. 2 is a schematic diagram of throwing the virtual object in the AR scenario provided in an embodiment of the present disclosure. As shown in FIG. 2, taking basket shooting in an office as an example, objects in the office are objects in a real world, and after the throwing parameter is determined according to the hand images, the basketball may be displayed according to the motion trajectory from the near to the distant. In addition, a basket and the like may also be loaded at a specified position in an office scenario, for example, a basket is loaded at the top of a door frame right ahead, and whether the basketball may hit the basket according to the motion trajectory may be determined according to the throwing parameter.

In the present embodiment, based on an engine and an AR platform, the AR scenario may be constructed in combination with the AR technology. For example, an Unreal Engine is a set of complete development tool, which faces any user who uses a real-time technology for work, and may implement the construction of high-quality scenarios from design visualization and movie-like experience to manufacturing hosts, mobile devices and AR platforms. In the present embodiment, the Unreal Engine may be selected as a game engine, which is responsible for related developments such as game scenarios, game logic and game display, and integrates related AR development components; as two implementable platforms, an ARCore software development kit (SDK) and an ARKit SDK are respectively responsible for the application of AR constructed by an Android platform and a mobile development framework of IOS AR, wherein the ARCore is a software platform for establishing an augmented reality application program, and the ArCore SDK combines virtual content with the real world by using functions such as motion tracking, environment understanding, illumination estimation and the like; and the ARKit SDK conveniently displays the AR scenario in combination with device motion tracking, camera scenario capture, advanced scenario processing and the like. Therefore, in the present embodiment, the combination of the Unreal Engine and the ArCore SDK may implement the construction of the AR scenario under the Android platform, and the combination of the Unreal Engine and the ARKit SDK may implement the construction of the AR scenario under an IOS platform.

After the AR scenario is established, the virtual object may be displayed in the AR scenario according to the motion trajectory, and the display manner is not limited in the present embodiment. Exemplarily, virtual targets such as a basket and a basketball may be placed in the AR scenario, the basketball is the virtual object, the throwing parameter may be determined by means of gesture recognition, and there is no need to trigger the basketball by means of touching a screen with a finger; and based on determining the throwing parameter, the motion trajectory of the basketball is simulated taking into account the position of the hand in the AR scenario and the speed of the relative movement, and finally, the information of the virtual object and a real world is displayed at corresponding positions in the AR scenario according to the pose of the electronic device. It should be noted that, if the pose of the electronic device is different, the range of the AR scenario that the user may see via the screen is also different, but the motion trajectory of the basketball and the position of the basket with respect to the real world should be kept fixed.

According to the virtual object display method in the present embodiment, the trigger gesture of throwing the virtual object is recognized from the hand images according to the three-dimensional coordinates of the hand key point; in response to the trigger gesture, the throwing parameter is determined according to the hand images; and the motion trajectory to throw the virtual object is simulated according to the throwing parameter, and the virtual object is displayed in the AR scenario according to the motion trajectory. In the method, when it is recognized that the hand changes from stationary to moving, the throwing is triggered, and the motion trajectory to throw the virtual object is simulated and displayed, thereby improving the accuracy of recognizing the trigger gesture, and the authenticity of simulating and displaying of the motion trajectory of the virtual object.

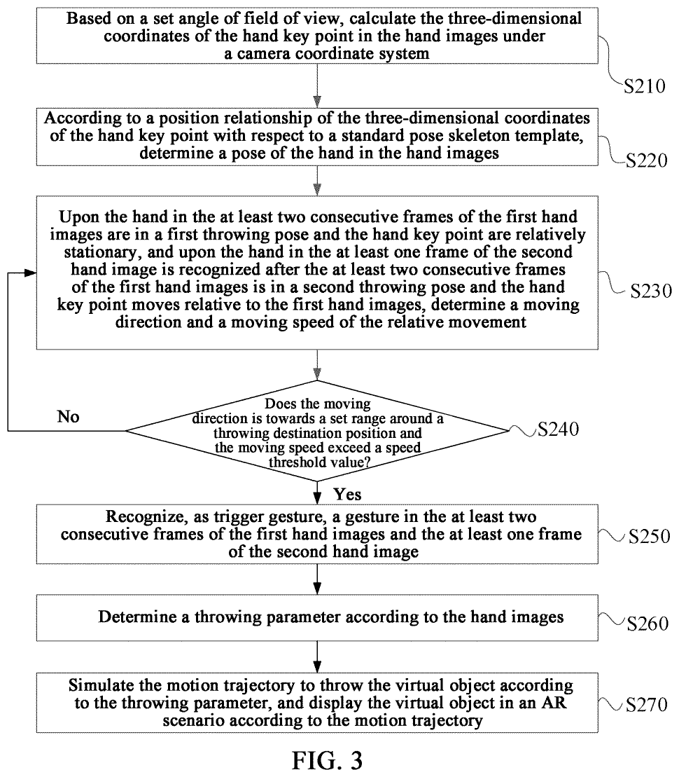

FIG. 3 is a schematic flowchart of a virtual object display method provided in another embodiment of the present disclosure. In the present embodiment, based on the above embodiment, the process of recognizing, according to the three-dimensional coordinates of the hand key point, the trigger gesture of throwing the virtual object from the hand images is embodied.

In the present embodiment, according to the three-dimensional coordinates of the hand key point, recognizing, from the hand images, the trigger gesture of throwing the virtual object, includes: based on a set angle of field of view, calculating the three-dimensional coordinates of the hand key point in the hand images under a camera coordinate system; according to a position relationship of the three-dimensional coordinates of the hand key point with respect to a standard pose skeleton template, determining the pose of hand in the hand images; and recognizing the trigger gesture according to the pose of the hand in the hand images. On this basis, the pose of the hand in the hand images may be accurately determined by using the standard pose skeleton template, so as to reliably recognize the trigger gesture.

In the present embodiment, recognizing the trigger gesture further includes: determining a moving direction and a moving speed of relative movement of the hand. On this basis, the moving direction and the moving speed of the relative movement of the hand may be determined in advance, so as to accurately recognize the trigger gesture.

In the present embodiment, after determining the moving direction and the moving speed of the relative movement of the hand, the method further includes: recognizing the thrown virtual object, and determining a throwing object destination position. On this basis, by means of recognizing the thrown virtual object and determining the throwing object destination position in advance, the throwing process of the virtual object can be accurately displayed.

On the above basis, recognizing the trigger gesture according to the pose of the hand in the hand images includes: if the at least two consecutive frames of the first hand images are recognized, the hand in the first hand images is in a first throwing pose and the hand key point is relatively stationary, at least one frame of second hand image is recognized after the at least two consecutive frames of first hand images, and the hand in the second hand image is in a second throwing pose and the hand key point moves relative to the first hand images, determining the moving direction and the moving speed of the relative movement; and if the moving direction is towards a set range around the throwing object destination position and the moving speed exceeds a speed threshold value, recognizing, as trigger gesture, a gesture in the at least two consecutive frames of first hand images and the at least one frame of the second hand image. On this basis, the trigger gesture is recognized according to the moving direction and the moving speed, thereby improving the accuracy of recognizing the trigger gesture.

As shown in FIG. 3, the virtual object display method provided in the other embodiment of the present disclosure includes the following steps:

S210, based on a set angle of field of view, calculating three-dimensional coordinates of a hand key point in hand images under a camera coordinate system.

The angle of field of view may be used for representing the range of field of view of a camera, for example, may be 30 degrees, 50 degrees or the like, and the angle of field of view may be pre-configured by the user, and may also be automatically set by the system.

For example, the angle of field of view may be set at first, the hand key point in the hand images are determined, and then the three-dimensional coordinates of the hand key point in the hand images are calculated under the camera coordinate system. The origin of the camera coordinate system is an optical center of the camera, the x axis and the y axis may be respectively parallel to the horizontal direction and the vertical direction of the hand images, and the z axis is an optical axis of the camera, which may be perpendicular to the plane of the hand images.

S220, according to a position relationship of the three-dimensional coordinates of the hand key point with respect to a standard pose skeleton template, determining the pose of hand in the hand images.

It can be understood that the standard pose may be a preset default pose, for example, five fingers of the hand are in a relaxed state, are naturally bent, or are straightened and close to each other, and so on; and the standard pose may also be a standard pose when throwing the virtual object, for example, the standard pose may be that the palm is curved to an arc shape to support the virtual object, and the standard pose may also be a gesture of grasping the virtual object with five fingers, and the like. The standard pose may be pre-configured by the user and may also be automatically set by the system, which is not limited in the present embodiment.

The skeleton template may be a template of a 3D human hand in the standard pose, which is used for describing 3D coordinates of a plurality of key points of the human hand and the position relationship among the plurality of key points in the standard pose.

For example, the pose of the hand in the hand images may be predicted by means of a neural network, and by means of the neural network and according to the position relationship of the three-dimensional coordinates of the hand key point with respect to the standard pose skeleton template, for example, according to the rotation and displacement and the like of each hand key point with respect to a standard position in the standard pose skeleton template, the pose of the hand in the hand images may be predicted.

Exemplarily, the pose of the hand in the hand images may also be determined according to the position relationship of a connecting line between the hand key point with respect to a corresponding bone in the standard pose skeleton template. For example, two hand key points in each hand image under the camera coordinate system may be connected to obtain a segment of skeleton, and the corresponding skeleton in the standard pose skeleton template is rotated or translated by means of predicting a transformation amount from the corresponding skeleton in the standard pose skeleton template to the bone, so as to obtain the three-dimensional coordinates of the hand key point in the hand image, thereby determining the pose of the hand in the hand image.

The following steps S230 and S240 involve recognizing a trigger gesture according to the pose of the hand in the hand images.

In the present embodiment, during the process of recognizing the trigger gesture, the method further includes: determining a moving direction and a moving speed of relative movement of the hand. The moving direction may be understood as the direction of the relative movement of the hand, and may be determined according to the direction of the speed and/or acceleration of the relative movement of the hand in several consecutive frames of hand images. For example, the acceleration of the relative movement of the hand may be determined according to the relative displacement of the hand and a movement time interval, and the moving direction of the relative movement of the hand may be determined by means of the direction of the acceleration of the movement of the hand. The moving speed may be understood as the speed of the relative movement of the hand, and may be determined by dividing the relative displacement of the hand in the several consecutive frames of hand images by the time interval of the relative displacement. The trigger gesture may be accurately recognized by means of determining the moving direction and the moving speed of the relative movement of the hand.

In the present embodiment, after determining the moving direction and the moving speed of the relative movement of the hand, the method further includes: recognizing a thrown virtual object, and determining a throwing object destination position. The virtual object may be understood as a thrown object, and the throwing object destination position may refer to a target position of the thrown virtual object, for example, when the virtual object is a basketball, the throwing object destination position may refer to a basket or a basket net. For example, the thrown virtual object may be recognized, and the throwing object destination position may be determined, so as to subsequently determine whether a throwing object is thrown to the destination location.

S230, when the hand in at least two consecutive frames of first hand images is in a first throwing pose and the hand key point is relatively stationary, and when it is recognized that the hand in at least one frame of second hand image after the at least two consecutive frames of first hand images is in a second throwing pose and the hand key point moves relative to the first hand images, determining a moving direction and a moving speed of the relative movement.

The first throwing pose and the second throwing pose may be understood as pose of the hand for throwing the virtual object, the first throwing pose and the second throwing pose are mainly distinguished according to different times, and the first throwing pose and the second throwing pose may be different from each other or not.

It can be understood that, when the hand in at least two consecutive frames of first hand images is in the first throwing pose and the hand key point is relatively stationary, and when it is recognized that the hand in at least one frame of second hand image after the at least two consecutive frames of first hand images is in the second throwing pose and the hand key point moves relative to the first hand images, it may be primarily determined that the gesture in the first hand images and the second hand image is trigger gesture. In the present embodiment, it is also possible to determine whether the gesture in the first hand images and the second hand image is the trigger gesture by means of determining the moving direction and the moving speed of the relative movement.

S240, determining whether the moving direction is towards a set range around a throwing object destination position and whether the moving speed exceeds a speed threshold value, and executing S250 based on a determination result that the moving direction faces the set range around the throwing object destination position and that the moving speed exceeds the speed threshold value; and based on a determination result that the moving direction is not towards the set range around the throwing object destination position and that the moving speed does not exceed the speed threshold value, returning to S230 to continue to recognize the first hand images and the second hand image, and to determine the moving direction and the moving speed of the relative movement.

The set range may refer to an area around a throwing destination position, and the throwing destination position may be, for example, the position of the basket net. For example, the set range is a fixed range near the basket net, and in the case where the moving direction faces the set range, the gesture in the first hand images and the second hand image may be trigger gesture; and the speed threshold value may be considered as a critical value for determining the trigger gesture, and in the case where the moving speed exceeds the speed threshold value, the gesture in the first hand images and the second hand image may be trigger gesture. In the present embodiment, if the moving direction faces the set range around the throwing object destination position and that the moving speed exceeds the critical value for triggering the moving speed, it is considered that the moving direction and the moving speed meet the condition of the trigger gesture. The set range and the speed threshold value may be pre-configured by the user, and may also be automatically set by the system, which is not limited in the present embodiment.

Based on step S240, when the moving direction faces the set range around the throwing object destination position and the moving speed exceeds the speed threshold value, it may be considered that the gesture in the first hand images and the hand in the second hand image is trigger gesture. At this time, the gesture in at least two consecutive frames of first hand images and at least one frame of second hand image are recognized as trigger gesture, and an operation for determining a throwing parameter may be executed; when the moving direction is not towards the set range around the throwing object destination position, or the moving speed does not exceed the speed threshold value, it may be considered that the gesture in the first hand images and the second hand image do not belong to trigger gesture, that is, a trigger operation for throwing the virtual object is not recognized, in this case, the collection of the hand images may be continued, or S230 is returned to continue to recognize whether the hand images contain other images in which the hand change from stationary to moving.

Exemplarily, if the user performs basket shooting with the index finger, the position of a key point on the fingertip of the index finger may be recognized, when the key point of the fingertip of the user first pauses for more than several frames (or may also be converted into several seconds), that is, the hand in two consecutive frames of hand images is in the throwing pose and the hand key point is relatively stationary, and then the moving speed on the side facing the basket exceeding the speed threshold value, it can be considered that the gesture in the hand images during this process belong to a basket shooting trigger gesture.

S250, recognizing, as trigger gesture, a gesture in the at least two consecutive frames of first hand images and the at least one frame of the second hand image.

S260, determining a throwing parameter according to the hand images.

S270, simulating a motion trajectory to throw the virtual object according to the throwing parameter, and displaying the virtual object in an AR scenario according to the motion trajectory.

According to the virtual object display method in the present embodiment, the pose of the hand in the hand images may be accurately determined by using the standard pose skeleton template, so as to reliably recognize the trigger gesture; when it is recognized that the hand in a plurality of frames of hand images change from stationary to moving, the trigger gesture is recognized according to the moving direction and the moving speed, the gesture is filtered according to the set range around the throwing object destination position and the speed threshold value, so that false recognition or false trigger can be effectively avoided, and the accuracy of recognizing the trigger gesture is improved by means of multiple determination, thereby providing a guarantee for the authenticity of simulating and displaying the motion trajectory of the virtual object.

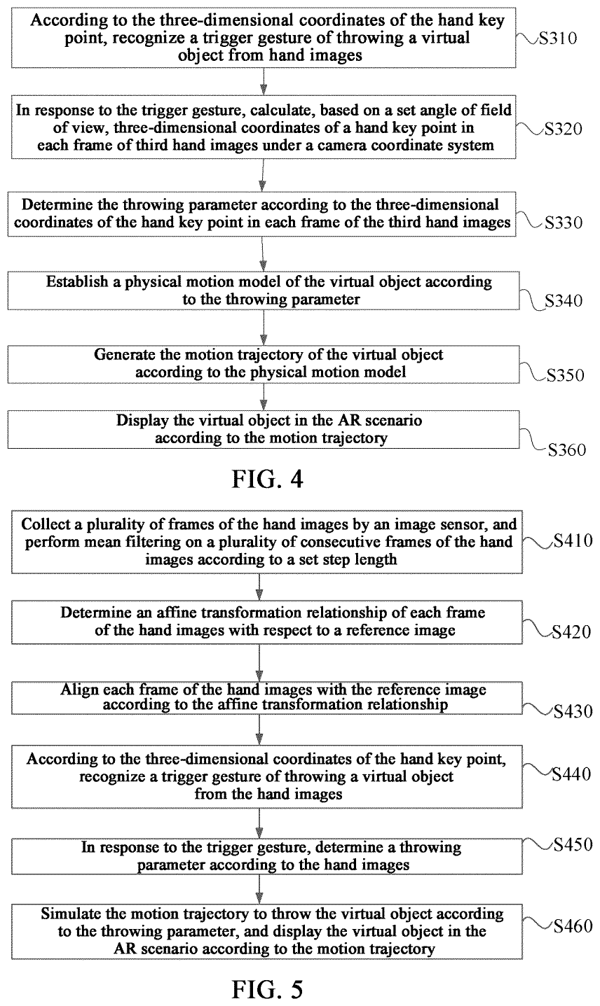

FIG. 4 is a schematic flowchart of a virtual object display method provided in another embodiment of the present disclosure. In the present embodiment, based on the above embodiments, the situation of determining the throwing parameter according to the hand images and simulating the motion trajectory to throw the virtual object according to the throwing parameter is embodied.

In the present embodiment, the hand images include at least two consecutive frames of third hand images, and the gesture in the third hand images is throwing gesture; determining the throwing parameter according to the hand images includes: based on a set angle of field of view, calculating three-dimensional coordinates of a hand key point in each frame of third hand images under a camera coordinate system; and determining the throwing parameter according to the three-dimensional coordinates of the hand key point in each frame of third hand images. On this basis, by means of determining the throwing parameter according to the third hand images containing valid throwing gestures, the interference of invalid gestures can be avoided, and the simulation and display efficiency is improved.

In the present embodiment, the throwing parameter includes a throwing force and a throwing direction; determining the throwing parameter according to the three-dimensional coordinates of the hand key point in each frame of third hand images includes: calculating a variation of the three-dimensional coordinates of the hand key point in each frame of third hand images with respect to the three-dimensional coordinates in the previous frame of hand images; and determining the throwing force according to a peak value of the variation, and using, as the throwing direction, a direction of the variation corresponding to the peak value. On this basis, the throwing parameter may be effectively determined, and a reliable basis is provided for simulating the motion trajectory.

In the present embodiment, before determining the throwing parameter according to the hand images, the method further includes: recognizing a first frame of third hand images and a last frame of third hand images in the hand images according to the pose of the hand in each frame of hand images and the moving speed of the relative movement of the hand in each frame of hand images with respect to the previous frame of hand images. On this basis, by means of recognizing the first frame of third hand images and the last frame of third hand images in the hand images, the moment of starting to throw the virtual object and the moment of stop throwing the virtual object may be determined, so as to subsequently simulate the motion trajectory to throw the virtual object.

In the present embodiment, recognizing the first frame of third hand images and the last frame of third hand images in the hand images according to the pose of the hand in each frame of hand images and the moving speed of the relative movement of the hand in each frame of hand images with respect to the previous frame of hand images, includes: if it is recognized that the hand in one frame of hand image is in the throwing pose and the moving speed of the relative movement with respect to the previous frame of hand images exceeds a first speed threshold value, using the frame of hand image as the first frame of third hand images; and if it is recognized that the hand in at least one frame of hand image is in the throwing pose and the moving speed of the relative movement with respect to the previous frame of hand images is lower than a second speed threshold value, using the frame of hand image as the last frame of third hand images. On this basis, the first frame of third hand images and the last frame of third hand images in the hand images can be accurately recognized, thereby ensuring the reliability of simulating the motion trajectory.

In the present embodiment, simulating the motion trajectory to throw the virtual object according to the throwing parameter includes: establishing a physical motion model of the virtual object according to the throwing parameter; and generating the motion trajectory of the virtual object according to the physical motion model. On this basis, the simulation of the motion trajectory has authenticity.

As shown in FIG. 4, the virtual object display method provided in the embodiment of the present disclosure includes the following steps:

S310, recognizing, according to three-dimensional coordinates of a hand key point, a trigger gesture of throwing a virtual object from hand images.

S320, in response to the trigger gesture, calculating, based on a set angle of field of view, three-dimensional coordinates of a hand key point in each frame of third hand images under a camera coordinate system.

It should be noted that, after the trigger gesture of throwing the virtual object in the first hand images and the second hand image is recognized, that is, it is considered that a trigger preparation before throwing is completed; ad on this basis, the throwing gesture in the third hand images may be recognized so as to determine a throwing parameter.

The hand images include at least two consecutive frames of third hand images, the third hand images may be considered as an image in a throwing process, and the gesture in the third hand images is the throwing gesture.

In the present step, the three-dimensional coordinates of the hand key point in each frame of third hand images under the camera coordinate system may be calculated based on the set angle of field of view, so as to provide a basis for determining the throwing parameter.

S330, determining a throwing parameter according to the three-dimensional coordinates of the hand key point in each frame of third hand images.

In the present embodiment, the three-dimensional coordinates of the hand key point in each frame of third hand images are obtained by means of the above steps, and then changes in the three-dimensional coordinates of the hand key point may be analyzed according to the three-dimensional coordinates of the hand key point in each frame of third hand images, so as to determine the throwing parameter accordingly, and the throwing parameter may be used for simulating the motion trajectory to throw the virtual object, wherein the throwing parameter may include, for example, a throwing force, a throwing direction, etc.

For example, determining the throwing parameter according to the three-dimensional coordinates of the hand key point in each frame of third hand images may include S331 and S332.

S331, calculating a variation of the three-dimensional coordinates of the hand key point in each frame of third hand images with respect to the three-dimensional coordinates in the previous frame of hand images.

In the present step, starting from the first frame in the third hand images, the variation of the three-dimensional coordinates of the hand key point in each frame of third hand images with respect to the three-dimensional coordinates in the previous frame of hand images is calculated, so that the variation corresponding to each frame of third hand images can be obtained, and a plurality of variations are used for representing the change conditions of the displacement of the hand in the throwing process.

S332, determining the throwing force according to peak values of a plurality of variations, and using, as the throwing direction, a direction of variations corresponding to the peak values.

The throwing force and the throwing direction in the throwing parameter may be determined by using the plurality of calculated variations, for example, the throwing force may be determined according to the peak values of the plurality of variations, and the direction of the variations corresponding to the peak values is used as the throwing direction.

It can be understood that, the throwing force may be determined according to the peak values of the plurality of variations, generally, the higher the peak value of the moving speed of the hand is, the greater the throwing force is, that is, the peak value and the throwing force are in a positive correlation relationship, for example, the peak value and the throwing force may be determined according to a positive proportion relationship, and the rule for specifically determining the throwing force according to the peak value is not limited in the present embodiment. Correspondingly, the greater the peak value is, the greater the initial speed of the virtual object being thrown out is.

S340, establishing a physical motion model of the virtual object according to the throwing parameter.

For example, the physical motion model of the virtual object may be established according to the throwing parameter obtained above, and analysis needs to be executed according to the throwing parameter in combination with the information of the real world during the process of establishing the physical motion model. For example, stress analysis is performed by means of the throwing force and the throwing direction in combination with the gravity of the virtual object and air resistance encountered in the throwing process, so as to establish the physical motion model of the virtual object.

S350, generating the motion trajectory of the virtual object according to the physical motion model.

When the motion trajectory of the virtual object is generated according to the physical motion model, corresponding motion trajectories need to be generated according to different situations.

Exemplarily, when the virtual object is a basketball, the user performs a basket shooting operation, the basket shooting result may be roughly divided into that the basketball enters the basket net, the basketball hits the backboard and is bounced back, the basketball is thrown to the periphery or edge of the basket net, but does not enter the basket net, and the like, and the motion trajectory of the basketball is generated according to the physical motion model in combination with the basket shooting result.

S360, displaying the virtual object in an AR scenario according to the motion trajectory.

In the present embodiment, the throwing parameter includes a throwing position, a throwing force and a throwing direction; and when the throwing force belongs to a force interval matching the throwing position, and the throwing direction belongs to a direction interval matching the throwing position, the motion trajectory of the virtual object passes through a throwing destination position.

The throwing position may be the position of the hand in the third hand images when the variation reaches the peak value; and the destination position may be considered as the throwing destination position, for example, may be the position where the basket net or the basket is located.

For example, whether the motion trajectory of the virtual object passes through the throwing destination position may be determined according to the throwing force and the throwing direction in combination with the throwing position. When the throwing force belongs to the force interval matching the throwing position, and the throwing direction belongs to the direction interval matching the throwing position, it can be considered that the motion trajectory of the virtual object passes through the throwing destination position, that is, the virtual object may hit the throwing destination position; and when the throwing force does not belong to the force interval matching the throwing position, or the throwing direction does not belong to the direction interval matching the throwing position, it can be considered that the motion trajectory of the virtual object does not pass through the throwing destination position, that is, the virtual object does not hit the throwing destination position.

In the present embodiment, before determining the throwing parameter according to the hand images, the method further includes: recognizing a first frame of third hand images and a last frame of third hand images in the hand images according to the pose of the hand in each frame of hand images and the moving speed of the relative movement of the hand in each frame of hand images with respect to the previous frame of hand images.

The third hand images may be considered as a plurality of frames of hand images in the throwing process, the gesture in the third hand images is throwing gesture, the first frame of third hand images may refer to a first frame of hand image in the throwing process, and the last frame of third hand images may refer to a last frame of hand image in the throwing process.

For example, the first frame of third hand images and the last frame of third hand images in the hand images may be recognized and determined according to the pose of the hand in each frame of hand images and the moving speed of the relative movement of the hand in each frame of hand images with respect to the previous frame of hand images.

For example, when it is recognized that the hand in one frame of hand image is in the throwing pose and the moving speed of the relative movement with respect to the previous frame of hand images exceeds a certain critical speed value, the frame of hand image is used as the first frame of third hand images; and when it is recognized that the hand in at least one frame of hand image is in the throwing pose and the moving speed of the relative movement with respect to the previous frame of hand images is lower than another critical speed value, the frame of hand image is used as the last frame of third hand images.

In the present embodiment, recognizing the first frame of third hand images and the last frame of third hand images in the hand images according to the pose of the hand in each frame of hand images and the moving speed of the relative movement of the hand in each frame of hand images with respect to the previous frame of hand images, includes:

if it is recognized that the hand in one frame of hand image is in the throwing pose and the moving speed of the relative movement with respect to the previous frame of hand images exceeds a first speed threshold value, using the frame of hand image as the first frame of third hand images; and if it is recognized that the hand in at least one frame of hand image is in the throwing pose and the moving speed of the relative movement with respect to the previous frame of hand images is lower than a second speed threshold value, using the frame of hand image as the last frame of third hand images.

The first speed threshold value may be considered as a critical speed value for starting the throwing process, the second speed threshold value may be considered as a critical speed value for ending the throwing process, and the first speed threshold value and the second speed threshold value may be pre-configured by the user, and may also be automatically set by the system, which is not limited in the present embodiment.

For example, if it is recognized that the hand in one frame of hand image is in the throwing pose and the moving speed of the relative movement with respect to the previous frame of hand images exceeds the first speed threshold value, it indicates that the hand image at this time is the first frame of image of starting the throwing, so that the frame of hand image is used as the first frame of third hand images; and if it is recognized that the hand in at least one frame of hand image is in the throwing pose and the moving speed of the relative movement with respect to the previous frame of hand images is lower than the second speed threshold value, it indicates that the hand image at this time is the last frame of image of the throwing, so that the frame of hand image is used as the last frame of third hand images.

For example, it can be understood that, when the motion speed exceeds the critical speed value for starting the throwing, the basket shooting action starts, and when the motion speed is lower than the critical speed value for ending the throwing, it is determined that the basket shooting action ends.

It should be noted that, the second hand image and the third hand images may have an intersection, that is, if the moving speed of one frame in the second hand image with respect to the previous frame exceeds the speed threshold value, the frame of second hand image may also be used as the third hand images for determining the throwing parameter.

On this basis, the throwing position, the throwing direction and the throwing force may be determined in the third hand images containing the valid throwing gesture without calculating and comparing the moving speeds and the moving directions of hand images other than the third hand images frame by frame, thereby improving the efficiency of simulating and displaying the motion trajectory.

According to the virtual object display method in the present embodiment, by means of determining the throwing parameter according to the variation of the three-dimensional coordinate of the hand key point in each frame of third hand images with respect to the three-dimensional coordinates in the previous frame of hand images, the interference of invalid gestures can be avoided, and the simulation and display efficiency is improved; by means of determining the throwing force according to the peak value of the variation, and using, as the throwing direction, a direction of the variation corresponding to the peak value, a reliable basis is provided for simulating the motion trajectory; and by means of establishing the physical motion model of the virtual object and performing stress analysis, the simulation of the motion trajectory has authenticity, thereby implementing accurate simulation and display of the motion trajectory of the virtual object.

FIG. 5 is a schematic flowchart of a virtual object display method provided in another embodiment of the present disclosure. Based on the above embodiments, a pre-processing process of hand images is embodied in the present embodiment.

In the present embodiment, before determining the throwing parameter according to the hand images in response to the trigger gesture of throwing the virtual object from the hand images, the method further includes: collecting a plurality of frames of hand images by an image sensor, and performing mean filtering on a plurality of consecutive frames of hand images according to a set step length. On this basis, the hand in the plurality of frames of hand images may be smoothed to eliminate errors of individual frames.

In the present embodiment, before determining the throwing parameter according to the hand images in response to the trigger gesture of throwing the virtual object from the hand images, the method further includes: determining an affine transformation relationship of each frame of hand images with respect to a reference image; and aligning each frame of hand images with the reference image according to the affine transformation relationship. On this basis, the hand in the plurality of frames of hand images may be aligned by means of the affine transformation relationship, so as to improve the accuracy of gesture recognition.

In the present embodiment, determining the affine transformation relationship of each frame of hand images with respect to the reference image includes: based on an optical flow method, calculating a coordinate deviation between a corner point of the hand in each frame of hand images and a corresponding corner point of the reference image; and according to the coordinate deviation, determining the affine transformation relationship of each frame of hand images with respect to the reference image. On this basis, the affine transformation relationship may be accurately determined by using corner points, so that the hand in the plurality of frames of hand images may be aligned, thus improving the accuracy of gesture recognition.

It should be noted that, there may be jitter or collision during the process when the user holds an electronic device, so that there are errors in the collected plurality of frames of hand images. Therefore, before the plurality of frames of hand images are analyzed and recognized, smoothing and alignment operations are performed on the collected plurality of frames of hand images. The following S410 to S440 may be considered as pre-processing of the hand images before the gestures in the hand images are recognized.

As shown in FIG. 5, the virtual object display method provided in the embodiment of the present disclosure includes the following steps:

S410, collecting a plurality of frames of hand images by an image sensor, and performing mean filtering on a plurality of consecutive frames of hand images according to a set step length.

Since there may be jitter or collision during the process when the user holds the electronic device, the positions of hand in one or more frames of images among the plurality of frames of hand images may be obviously different from those in other frames, for example, being higher or lower, so that there are errors among the plurality of frames of hand images. In this case, after the image sensor collects the plurality of frames of hand images, the mean filtering may be performed on the plurality of consecutive frames of hand images according to the set step length. For example, a sliding window is provided, five frames of hand images are contained in the sliding window, the sliding window is caused to slide according to a step length of two frames each time, thus performing smoothing processing on the hand in the plurality of frames of hand images, so as to recover the images of abnormal frames to normal positions to eliminate errors in the hand images.

S420, determining an affine transformation relationship of each frame of hand images with respect to a reference image.

The reference image may be one frame of image among the plurality of frames of hand images, and is used as a reference for aligning the plurality of frames of hand images, the reference image is, for example, a first frame of image among the plurality of frames of hand images, and may also be any frame of image among the plurality of frames of hand images, or, the reference image of each frame of hand images may be a previous frame of hand images adjacent thereto; and the affine transformation relationship includes zooming, rotation, reflection and/or shear mapping, etc.

For example, a coordinate deviation between a point in each frame of hand images and a corresponding point in the reference image may be calculated; and the affine transformation relationship of each frame of hand images with respect to the reference image is determined according to the coordinate deviation.

For example, determining the affine transformation relationship of each frame of hand images with respect to the reference image may include S421 and S422.

S421, based on an optical flow method, calculating a coordinate deviation between a corner point of the hand in each frame of hand images and a corresponding corner point of the reference image.

It is considered that the corner point is a salient point that may be used for distinguishing the hand from the background, and the corner point may be used for reflecting the position of the hand, for example, a fingertip or the boundary of a finger seam, etc.

In the present embodiment, the coordinate deviation between the corner point of the hand in each frame of hand images and the corresponding corner point of the selected reference image may be calculated based on the optical flow method. The optical flow method is a method in which a correspondence between the previous frame and the current frame is discovered by using changes of pixels in an image sequence in a time domain and the correlation between adjacent frames, so as to calculate motion information of an object between the adjacent frames. The coordinate deviation of the corner points is calculated based on the optical flow method, so as to determine the affine transformation relationship of each frame of hand images with respect to the reference image.

S422, determining an affine transformation relationship of each frame of hand images with respect to the reference image according to the coordinate deviation.

The affine transformation relationship of each frame of hand images with respect to the reference image is determined according to the obtained coordinate deviation, so that each frame of hand images can be aligned with the reference image.

S430, aligning each frame of hand images with the reference image according to the affine transformation relationship.

For example, since the angles of collecting the hand images are different, and there are jitters or errors and the like, the plurality of frames of hand images are not aligned, and the jitter and the like may be determined as movement of hand key point. In the present embodiment, the plurality of frames of hand images are aligned according to the affine transformation relationship, so that false recognition can be avoided, and the accuracy of gesture recognition is improved.

S440, recognizing, according to three-dimensional coordinates of a hand key point, a trigger gesture of throwing a virtual object from hand images.

S450, in response to the trigger gesture, determining a throwing parameter according to the hand images.

S460, simulating a motion trajectory to throw the virtual object according to the throwing parameter, and displaying the virtual object in an AR scenario according to the motion trajectory.

In one embodiment, displaying the virtual object in the AR scenario according to the motion trajectory includes: detecting the pose of an electronic device by means of a motion sensor; and according to the pose of the electronic device, displaying, at corresponding positions in the AR scenario, the motion trajectory of the virtual object, and real world information collected by an image sensor of the electronic device.

The motion sensor includes, but is not limited to, a gravity sensor, an acceleration sensor and/or a gyroscope, or the like. Firstly, the pose of the electronic device may be detected by means of the motion sensor, and then the motion trajectory of the virtual object and the real world information collected by the image sensor of the electronic device are displayed at corresponding positions in the AR scenario according to the pose of the electronic device, that is, the direction and orientation of the AR scenario are adaptively adjusted by means of gravity sensing and motion sensing, and the characteristics, such as gravity and magnetic force, in the real world are combined into the AR scenario. It should be noted that, if the pose of the electronic device is different, the range of the AR scenario that the user may see by means of the screen is also different, but the position of the motion trajectory of the virtual object with respect to the real world information in the AR scenario should be kept fixed.

In one embodiment, the method further includes: rendering the AR scenario to display at least one of the following in the AR scenario: illumination in the AR scenario and a shadow formed by the virtual object under the illumination; texture of the virtual object; a visual special effect of the AR scenario; and throwing result information of the virtual object.

For example, when the AR scenario is rendered, illumination shadows, material texture, visual special effects, post-processing and the like may be loaded, so as to build a virtual reality scenario and enhance the interestingness and visualization effect of throwing the virtual object.

For example, when the thrown virtual object is a basketball, in addition to displaying the basketball in the AR scenario according to the motion trajectory, a shadow formed by the illumination of a surrounding environment during the motion process of the basketball may also be loaded in the AR scenario; texture features of the virtual object may also be rendered, for example, patterns and colors are added to the basketball; the visual special effects may also be increased, for example, when the basketball collides with the basket, a shake or deformation special effect is added to the basket; and after the throwing process is finished, the throwing result information may also be displayed, for example, integration is performed according to a plurality of throwing results, and nouns or a ranking list and the like are displayed according to the points of different rounds or different users, so as to enhance the interestingness and to form an interactive playing method.

According to the virtual object display method in the present embodiment, for example, when the AR scenario is rendered, illumination shadows, material texture, the visual special effects, post-processing and the like may be loaded, so as to build the virtual reality scenario. In the method, smoothing and alignment processing are performed on the plurality of frames of hand images before the hand images are recognized, so as to eliminate errors in the plurality of frames of hand images and to improve the accuracy of gesture recognition, thereby improving the authenticity of displaying the motion trajectory of the virtual object; and by means of rendering the AR scenario, the interestingness and visualization effect of throwing the virtual object are enhanced, and the user experience in the throwing process is improved.

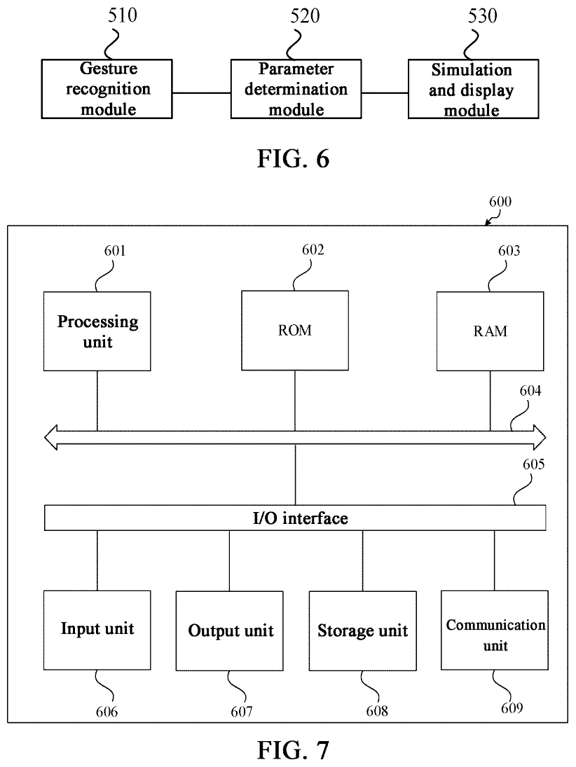

FIG. 6 is a schematic structural diagram of a virtual object display apparatus provided in an embodiment of the present disclosure. For content that is not described in detail in the present embodiment, reference may be made to the above embodiments.

As shown in FIG. 6, the apparatus includes:

a gesture recognition module 510, configured to: recognize, according to three-dimensional coordinates of a hand key point, a trigger gesture of throwing a virtual object from hand images, wherein the hand images include at least two consecutive frames of first hand images in which the hand key point is relatively stationary, at least one frame of second hand image in which the hand key point moves relative to the first hand images, and a gesture in the first hand images and/or the second hand image is the trigger gesture;
a parameter determination module 520, configured to: in response to the trigger gesture, determine a throwing parameter according to the hand images; and
a simulation and display module 530, configured to: simulate a motion trajectory to throw the virtual object according to the throwing parameter, and display the virtual object in an AR scenario according to the motion trajectory.

According to the virtual object display apparatus in the present embodiment, the throwing is triggered when it is recognized that the hand changes from stationary to moving, and the motion trajectory of the virtual object is simulated and displayed, thereby improving the accuracy of recognizing the trigger gesture, and improving the authenticity of simulating and displaying of the motion trajectory of the virtual object.

On the above basis, the gesture recognition module 510 includes:
a first calculation unit, configured to: based on a set angle of field of view, calculate the three-dimensional coordinates of the hand key point in the hand images under a camera coordinate system;
a pose determination unit, configured to: according to a position relationship of the three-dimensional coordinates of the hand key point with respect to a standard pose skeleton template, determine the pose of hand in the hand images; and
a gesture recognition unit, configured to recognize the trigger gesture according to the pose of the hand in the hand images.

On the above basis, the gesture recognition module 510 is further configured to determine a moving direction and a moving speed of relative movement of the hand.

On the above basis, after determining the moving direction and the moving speed of the relative movement of the hand, the apparatus further includes a throwing object destination position determination module, configured to:

recognize the thrown virtual object, and determine a throwing object destination position.

On the above basis, the gesture recognition unit is configured to:
if the at least two consecutive frames of the first hand images are recognized, the hand in the first hand images is in a first throwing pose and the hand key point is relatively stationary, at least one frame of second hand image is recognized after the at least two consecutive frames of first hand images, and the hand in the second hand image is in a second throwing pose and the hand key point moves relative to the first hand images, determine the moving direction and the moving speed of the relative movement; and
if the moving direction is towards a set range around the throwing object destination position and the moving speed exceeds a speed threshold value, recognize the gesture in the at least two consecutive frames of first hand images and the at least one frame of the second hand image as trigger gesture.

On the above basis, the hand images includes at least two consecutive frames of third hand images, and the gestures of hand in the third hand images is throwing gesture;
the parameter determination module 520 includes:
a second calculation unit, configured to: based on the set angle of field of view, calculate three-dimensional coordinates of a hand key point in each frame of third hand images under the camera coordinate system; and
a parameter determination unit, configured to determine the throwing parameter according to the three-dimensional coordinates of the hand key point in each frame of third hand images.

On the above basis, the throwing parameter includes a throwing force and a throwing direction;
the parameter determination unit is configured to:
calculate a variation of the three-dimensional coordinates of the hand key point in each frame of third hand images with respect to the three-dimensional coordinates in the previous frame of hand images; and
determine the throwing force according to a peak value of the variation, and use, as the throwing direction, the direction of the variation corresponding to the peak value.

On the above basis, before determining the throwing parameter according to the hand images, the apparatus further includes:
an image recognition module, configured to:
recognize a first frame of third hand images and a last frame of third hand images in the hand images according to the pose of the hand in each frame of hand images and the moving speed of the relative movement of the hand in each frame of hand images with respect to the previous frame of hand images.

On the above basis, the image recognition module is configured to: if it is recognized that the hand in one frame of hand image is in the throwing pose and the moving speed of the relative movement with respect to the previous frame of hand images exceeds a first speed threshold value, use the frame of hand image as the first frame of third hand images; and
if it is recognized that the hand in at least one frame of hand image is in the throwing pose and the moving speed of the relative movement with respect to the previous frame of hand images is lower than a second speed threshold value, use the frame of hand image as the last frame of third hand images.

On the above basis, the simulation and display module 530 includes:
a modeling unit, configured to establish a physical motion model of the virtual object according to the throwing parameter; and
a generation unit, configured to generate the motion trajectory of the virtual object according to the physical motion model.

On the above basis, the throwing parameter includes a throwing position, a throwing force and a throwing direction; and
when the throwing force belongs to a force interval matching the throwing position, and the throwing direction belongs to a direction interval matching the throwing position, the motion trajectory of the virtual object passes through a throwing destination position.

On the above basis, before determining the throwing parameter according to the hand images in response to the trigger gesture of throwing the virtual object from the hand images, the apparatus further includes:
a relationship determination module, configured to determine an affine transformation relationship of each frame of hand images with respect to a reference image; and
an alignment module, configured to align each frame of hand images with the reference image according to the affine transformation relationship.

On the above basis, the relationship determination module is configured to:
based on an optical flow method, calculate a coordinate deviation between a corner point of the hand in each frame of hand images and a corresponding corner point of the reference image; and
determine the affine transformation relationship of each frame of hand images with respect to the reference image according to the coordinate deviation.

On the above basis, before determining the throwing parameter according to the hand images in response to the trigger gesture of throwing the virtual object from the hand images, the apparatus further includes: a smoothing module, configured to:
collect a plurality of frames of hand images by an image sensor, and perform mean filtering on a plurality of consecutive frames of hand images according to a set step length.

On the above basis, the apparatus further includes a rendering module, configured to:
render the AR scenario to display at least one of the following in the AR scenario:
illumination in the AR scenario and a shadow formed by the virtual object under the illumination;
texture of the virtual object;
a visual special effect of the AR scenario; and
throwing result information of the virtual object.

The virtual object display apparatus may execute the virtual object display method provided in any embodiment of the present disclosure, and has corresponding functional modules and beneficial effects for executing the method.

FIG. 7 is a schematic diagram of a hardware structure of an electronic device provided in an embodiment of the present disclosure. FIG. 7 illustrates a schematic structural diagram of an electronic device 600 suitable for implementing the embodiments of the present disclosure. The electronic device 600 in the embodiment of the present disclosure may include, but is not limited to, devices having image processing functions, such as computers, notebook computers, servers, tablet computers or smart phones. The electronic device shown in FIG. 7 is merely an example, and should not bring any limitation to the functions and use ranges of the embodiments of the present disclosure.

As shown in FIG. 7, the electronic device 600 may include one or more processing units (e.g., a central processing unit, a graphics processing unit, or the like) 601, which may execute various suitable actions and processes in accordance with a program stored in a read only memory (ROM) 602 or a program loaded from a storage unit 608 into a random access memory (RAM) 603. The one or more processing units 601 implement a traffic data packet forwarding method provided in the present disclosure. In the RAM 603, various programs and data needed by the operations of the electronic device 600 are also stored. The processing unit 601, the ROM 602 and the RAM 603 are connected with each other via a bus 605. An input/output (I/O) interface 604 is also connected to the bus 605.

In general, the following apparatuses may be connected to the I/O interface 604: an input unit 606, including, for example, a touch screen, a touch pad, a keyboard, a mouse, a camera, a microphone, an accelerometer, a gyroscope, and the like; an output unit 607, including, for example, a liquid crystal display (LCD), a speaker, a vibrator, and the like; a storage unit 608, including, for example, a magnetic tape, a hard disk, and the like, and the storage unit 608 is configured to store one or more programs; and a communication unit 609. The communication unit 609 may allow the electronic device 600 to communicate in a wireless or wired manner with other devices to exchange data. Although FIG. 7 illustrates the electronic device 600 having a plurality of apparatuses, it should be understood that not all illustrated apparatuses are required to be implemented or provided. More or fewer apparatuses may alternatively be implemented or provided.

In particular, according to the embodiments of the present disclosure, the processes described above with reference to the flowcharts may be implemented as computer software programs. For example, the embodiments of the present disclosure include a computer program product, which includes a computer program carried on a non-transient computer-readable medium, and the computer program contains program codes for executing the method illustrated in the flowcharts. In such embodiments, the computer program may be downloaded and installed from a network via the communication unit 609, or installed from the storage unit 608, or installed from the ROM 602. When the computer program is executed by the processing unit 601, the above functions defined in the method of the embodiments of the present disclosure are executed.

It should be noted that, the computer-readable medium described above in the present disclosure may be either a computer-readable signal medium or a computer-readable storage medium, or any combination of the two. The computer-readable storage medium may be, for example, but is not limited to, an electrical, magnetic, optical, electromagnetic, infrared, or semiconductor system, apparatus or device, or a combination of any of the above. More specific examples of the computer-readable storage medium may include, but are not limited to: an electrical connection having one or more wires, a portable computer magnetic disk, a hard disk, a random access memory (RAM), a read only memory (ROM), an erasable programmable read only memory (EPROM or a flash memory), an optical fiber, a portable compact disc-read only memory (CD-ROM), an optical storage device, a magnetic storage device, or any suitable combination of the above. In the present disclosure, the computer-readable storage medium may be any tangible medium that contains or stores a program, wherein the program may be used by or in combination with an instruction execution system, apparatus or device. In the present disclosure, the computer-readable signal medium may include a data signal that is propagated in a baseband or used as part of a carrier, wherein the data signal carries computer-readable program codes. Such propagated data signal may take many forms, including, but not limited to, electromagnetic signals, optical signals, or any suitable combination thereof. The computer-readable signal medium may also be any computer-readable medium other than the computer-readable storage medium, and the computer-readable signal medium may send, propagate or transport the program for use by or in combination with the instruction execution system, apparatus or device. Program codes contained on the computer-readable medium may be transmitted with any suitable medium, including, but not limited to: an electrical wire, an optical cable, RF (radio frequency), and the like, or any suitable combination thereof.

In some embodiments, a client and a server may perform communication by using any currently known or future-developed network protocol, such as an HTTP (HyperText Transfer Protocol), and may be interconnected with any form or medium of digital data communication (e.g., a communication network). Examples of the communication network include a local area network (“LAN”), a wide area network (“WAN”), an international network (e.g., the Internet), and a peer-to-peer network (e.g., an ad hoc peer-to-peer network), as well as any currently known or future-developed network.

The computer-readable medium may be contained in the above electronic device; and it may also be present separately and is not assembled into the electronic device.

The computer-readable medium carries one or more programs that, when executed by the electronic device, cause the electronic device to perform the following operations: recognizing, according to three-dimensional a coordinates of hand key point, a trigger gesture of throwing a virtual object from hand images, wherein the hand images include at least two consecutive frames of first hand images in which the hand key point is relatively stationary, at least one frame of second hand image in which the hand key point moves relative to the first hand images, and a gesture in the first hand images and/or the second hand image is the trigger gesture; in response to the trigger gesture, determining a throwing parameter according to the hand images; and simulating a motion trajectory to throw the virtual object according to the throwing parameter, and displaying the virtual object in an AR scenario according to the motion trajectory.

Computer program codes for executing the operations of the present disclosure may be written in one or more programming languages or combinations thereof. The programming languages include, but are not limited to, object-oriented programming languages, such as Java, Smalltalk, C++, and conventional procedural programming languages, such as the “C” language or similar programming languages. The program codes may be executed entirely on a user computer, executed partly on the user computer, executed as a stand-alone software package, executed partly on the user computer and partly on a remote computer, or executed entirely on the remote computer or a server. In the case involving the remote computer, the remote computer may be connected to the user computer by means of any type of network, including a local area network (LAN) or a wide area network (WAN), or it may be connected to an external computer (e.g., by means of the Internet using an Internet service provider).

The flowcharts and block diagrams in the drawings illustrate the system architecture, functions and operations of possible implementations of systems, methods and computer program products according to various embodiments of the present disclosure. In this regard, each block in the flowcharts or block diagrams may represent a part of a module, a program segment, or a code, which contains one or more executable instructions for implementing specified logical functions. It should also be noted that, in some alternative implementations, the functions annotated in the block may occur out of the sequence annotated in the drawings. For example, two blocks shown in succession may, in fact, be executed substantially concurrently, or the blocks may sometimes be executed in a reverse sequence, depending upon the functions involved. It should also be noted that, each block in the block diagrams and/or flowcharts, and combinations of the blocks in the block diagrams and/or flowcharts may be implemented by dedicated hardware-based systems for executing specified functions or operations, or combinations of dedicated hardware and computer instructions.

The units involved in the described embodiments of the present disclosure may be implemented in a software or hardware manner. The names of the units do not constitute limitations of the units themselves in a certain case.

The functions described herein above may be executed, at least in part, by one or more hardware logic components. For example, without limitation, example types of the hardware logic components that may be used include: a field programmable gate array (FPGA), an application specific integrated circuit (ASIC), an application specific standard product (ASSP), a system on chip (SOC), a complex programmable logic device (CPLD), and so on.

In the context of the present disclosure, a machine-readable medium may be a tangible medium, which may contain or store a program for use by or in combination with the instruction execution system, apparatus or device. The machine-readable medium may be a machine-readable signal medium or a machine-readable storage medium. The machine-readable medium may include, but is not limited to, an electronic, magnetic, optical, electromagnetic, infrared, or semiconductor system, apparatus or device, or any suitable combination thereof. More specific examples of the machine-readable storage medium would include an electrical connection based on one or more wires, a portable computer disk, a hard disk, a random access memory (RAM), a read only memory (ROM), an erasable programmable read only memory (EPROM or a flash memory), an optical fiber, a compact disc-read only memory (CD-ROM), an optical storage device, a magnetic storage device, or any suitable combination thereof.

According to one or more embodiments of the present disclosure, Example 1 provides a virtual object display method, including:
recognizing, according to three-dimensional coordinates of a hand key point, a trigger gesture of throwing a virtual object from hand images, wherein the hand images include at least two consecutive frames of first hand images in which the hand key point is relatively stationary, at least one frame of second hand image in which the hand key point moves relative to the first hand images, and a gesture in the first hand images and/or the second hand image is the trigger gesture;
in response to the trigger gesture, determining a throwing parameter according to the hand images; and
simulating a motion trajectory to throw the virtual object according to the throwing parameter, and displaying the virtual object in an AR scenario according to the motion trajectory.

According to the method in Example 1, in Example 2, according to the three-dimensional coordinates of the hand key point, recognizing, from the hand images, the trigger gesture of throwing the virtual object, includes:
based on a set angle of field of view, calculating the three-dimensional coordinates of the hand key point in the hand images under a camera coordinate system;
according to a position relationship of the three-dimensional coordinates of the hand key point with respect to a standard pose skeleton template, determining the pose of hand in the hand images; and
recognizing the trigger gesture according to the pose of the hand in the hand images.

According to the method in Example 1 or 2, in Example 3, recognizing the trigger gesture further includes: determining a moving direction and a moving speed of relative movement of the hand.

According to the method in Example 3, in Example 4, after determining the moving direction and the moving speed of the relative movement of the hand, the method further includes:
recognizing the thrown virtual object, and determining a throwing object destination position.

According to the method in Example 4, in Example 5, recognizing the trigger gesture according to the pose of the hand in the hand images includes:
if the at least two consecutive frames of the first hand images are recognized, the hand in the first hand images is in a first throwing pose and the hand key point is relatively stationary, at least one frame of second hand image is recognized after the at least two consecutive frames of first hand images, and the hand in the second hand image is in a second throwing pose and the hand key point moves relative to the first hand images, determining the moving direction and the moving speed of the relative movement; and
if the moving direction is towards a set range around the throwing object destination position and the moving speed exceeds a speed threshold value, recognizing, as trigger gesture, a gesture in the at least two consecutive frames of first hand images and the at least one frame of the second hand image.

According to the method in Example 1, in Example 6, the hand images include at least two consecutive frames of third hand images, and the gesture in the third hand images is throwing gesture;
determining the throwing parameter according to the hand images includes:
based on a set angle of field of view, calculating three-dimensional coordinates of a hand key point in each frame of third hand images under a camera coordinate system; and
determining the throwing parameter according to the three-dimensional coordinates of the hand key point in each frame of third hand images.

According to the method in Example 6, in Example 7, the throwing parameter includes a throwing force and a throwing direction;
determining the throwing parameter according to the three-dimensional coordinates of the hand key point in each frame of third hand images includes:
calculating a variation of the three-dimensional coordinates of the hand key point in each frame of third hand images with respect to the three-dimensional coordinates in the previous frame of hand images; and
determining the throwing force according to a peak value of the variation, and using, as the throwing direction, a direction of the variation corresponding to the peak value.

According to the method in Example 6, in Example 8, before determining the throwing parameter according to the hand images, the method further includes:
recognizing a first frame of third hand images and a last frame of third hand images in the hand images according to the pose of the hand in each frame of hand images and the moving speed of the relative movement of the hand in each frame of hand images with respect to the previous frame of hand images.

According to the method in Example 8, in Example 9, recognizing the first frame of third hand images and the last frame of third hand images in the hand images according to the pose of the hand in each frame of hand images and the moving speed of the relative movement of the hand in each frame of hand images with respect to the previous frame of hand images, includes:
if it is recognized that the hand in one frame of hand image is in the throwing pose and the moving speed of the relative movement with respect to the previous frame of hand images exceeds a first speed threshold value, using the frame of hand image as the first frame of third hand images; and
if it is recognized that the hand in at least one frame of hand image is in the throwing pose and the moving speed of the relative movement with respect to the previous frame of hand images is lower than a second speed threshold value, using the frame of hand image as the last frame of third hand images.

According to the method in Example 1, in Example 10, simulating the motion trajectory to throw the virtual object according to the throwing parameter includes:
establishing a physical motion model of the virtual object according to the throwing parameter; and
generating the motion trajectory of the virtual object according to the physical motion model.

According to the method in Example 1, in Example 11, the throwing parameter includes a throwing position, a throwing force and a throwing direction; and
when the throwing force belongs to a force interval matching the throwing position, and the throwing direction belongs to a direction interval matching the throwing position, the motion trajectory of the virtual object passes through a throwing destination position.

According to the method in Example 1, in Example 12, before determining the throwing parameter according to the hand images in response to the trigger gesture of throwing the virtual object from the hand images, the method further includes:
determining an affine transformation relationship of each frame of hand images with respect to a reference image; and
aligning each frame of hand images with the reference image according to the affine transformation relationship.

According to the method in Example 12, in Example 13, determining the affine transformation relationship of each frame of hand images with respect to the reference image includes:
based on an optical flow method, calculating a coordinate deviation between a corner point of the hand in each frame of hand images and a corresponding corner point of the reference image; and
according to the coordinate deviation, determining the affine transformation relationship of each frame of hand images with respect to the reference image.

According to the method in Example 1, in Example 14, before determining the throwing parameter according to the hand images in response to the trigger gesture of throwing the virtual object from the hand images, the method further includes:
collecting a plurality of frames of hand images by an image sensor, and performing mean filtering on a plurality of consecutive frames of hand images according to a set step length.

According to the method in Example 1, in Example 15, the method further includes:
rendering the AR scenario to display at least one of the following in the AR scenario:
illumination in the AR scenario and a shadow formed by the virtual object under the illumination;
texture of the virtual object;
a visual special effect of the AR scenario; and
throwing result information of the virtual object.

According to one or more embodiments of the present disclosure, Example 16 provides a virtual object display apparatus, including:
a gesture recognition module, configured to: according to three-dimensional coordinates of a hand key point, recognize, from hand images, a trigger gesture of throwing a virtual object, wherein the hand images include at least two consecutive frames of first hand images in which the hand key point is relatively stationary, at least one frame of second hand image in which the hand key point moves relative to the first hand images, and a gesture in the first hand images and/or the second hand image is the trigger gesture;
a parameter determination module, configured to: in response to the trigger gesture, determine a throwing parameter according to the hand images; and
a simulation and display module, configured to: simulate a motion trajectory to throw the virtual object according to the throwing parameter, and display the virtual object in an AR scenario according to the motion trajectory.

According to one or more embodiments of the present disclosure, Example 17 provides an electronic device, including:
one or more processors; and
a storage, configured to store one or more programs, wherein,
when the one or more programs are executed by the one or more processors, the one or more processors implement the virtual object display method according to any one of Examples 1-15.

According to one or more embodiments of the present disclosure, Example 18 provides a computer-readable medium, on which a computer program is stored, wherein the program, when being executed by a processor, implements the virtual object display method according to any one of Examples 1-15.

In addition, although a plurality of operations are described in a particular order, this should not be understood as requiring that these operations are executed in the particular sequence shown or in a sequential order. In certain circumstances, multitasking and parallel processing may be advantageous. Similarly, although several specific implementation details have been contained in the above discussion, these should not be construed as limiting the scope of the present disclosure. Certain features that are described in the context of separate embodiments may also be implemented in combination in a single embodiment. Conversely, a plurality of features that are described in the context of a single embodiment may also be implemented in a plurality of embodiments separately or in any suitable sub-combination.

What is claimed is:

1. A virtual object display method, comprising:
recognizing, according to three-dimensional coordinates of a hand key point, a trigger gesture of throwing a virtual object from hand images, wherein the hand images comprise at least two consecutive frames of first hand images in which the hand key point is relatively stationary, at least one frame of a second hand image in which the hand key point moves relative to the first hand images, and a gesture in at least one of the first hand images and the second hand image is the trigger gesture;
in response to the trigger gesture, determining a throwing parameter according to the hand images; and
simulating a motion trajectory to throw the virtual object according to the throwing parameter, and displaying the virtual object in an augmented reality (AR) scenario according to the motion trajectory.

2. The method of claim 1, wherein recognizing, according to the three-dimensional coordinates of the hand key point, the trigger gesture of throwing the virtual object from the hand images, comprises:
calculating, based on a set angle of field of view, the three-dimensional coordinates of the hand key point in the hand images under a camera coordinate system;
determining, according to a position relationship of the three-dimensional coordinates of the hand key point with respect to a standard pose skeleton template, a pose of the hand in the hand images; and
recognizing, according to the pose of the hand in the hand images, the trigger gesture.

3. The method of claim 2, wherein recognizing the trigger gesture further comprises: determining a moving direction and a moving speed of relative movement of the hand.

4. The method of claim 3, after determining the moving direction and the moving speed of the relative movement of the hand, the method further comprises:
recognizing the thrown virtual object, and determining a throwing object destination position.

5. The method of claim 4, wherein recognizing, according to the pose of the hand in the hand images, the trigger gesture, comprises:
in response to determining that the at least two consecutive frames of the first hand images are recognized, the hand in the first hand images is in a first throwing pose and the hand key point is relatively stationary, and that the at least one frame of the second hand image is recognized after the at least two consecutive frames of the first hand images, the hand in the second hand image is in a second throwing pose and the hand key point moves relative to the first hand images, determining the moving direction and the moving speed of the relative movement; and
in response to determining that the moving direction is towards a set range around the throwing object destination position and that the moving speed exceeds a speed threshold value, recognizing, as the trigger gesture, a gesture in the at least two consecutive frames of the first hand images and the at least one frame of the second hand image.

6. The method of claim 1, wherein the hand images comprise at least two consecutive frames of third hand images, and the gesture in the third hand images is throwing gesture;
determining, according to the hand images, the throwing parameter, comprises:
calculating, based on a set angle of field of view, three-dimensional coordinates of a hand key point in each frame of the third hand images under a camera coordinate system; and
determining, according to the three-dimensional coordinates of the hand key point in each frame of the third hand images, the throwing parameter.

7. The method of claim 6, wherein the throwing parameter comprises a throwing force and a throwing direction;
determining, according to the three-dimensional coordinates of the hand key point in each frame of the third hand images, the throwing parameter, comprises:
calculating a variation of the three-dimensional coordinates of the hand key point in each frame of the third hand images with respect to the three-dimensional coordinates in the previous frame of hand images; and
determining the throwing force according to a peak value of the variation, and using, as the throwing direction, a direction of the variation corresponding to the peak value.

8. The method of claim 6, before determining the throwing parameter according to the hand images, the method further comprises:
recognizing a first frame of the third hand images and a last frame of the third hand images in the hand images according to the pose of the hand in each frame of the hand images and the moving speed of the relative movement of the hand in each frame of the hand images with respect to the previous frame of the hand images.

9. The method of claim 8, wherein recognizing, according to the pose of the hand in each frame of the hand images and the moving speed of the relative movement of the hand in each frame of the hand images with respect to the previous frame of the hand images, the first frame of the third hand images and the last frame of the third hand images in the hand images, comprises:
in response to determining that the hand in one frame of the hand images is in the throwing pose and the moving speed of the relative movement with respect to the previous frame of the hand images exceeds a first speed threshold value are recognized, using, as the first frame of the third hand images, a frame of the hand images in which the hand is in the throwing pose and the moving speed of the relative movement with respect to the previous frame of the hand images exceeds the first speed threshold value; and
in response to determining that the hand in at least one frame of the hand images is in the throwing pose and the moving speed of the relative movement with respect to the previous frame of the hand images is lower than a second speed threshold value are recognized, using, as the last frame of the third hand images, a last frame of the hand images in the at least one frame of the hand images in which the hand is in the throwing pose and the moving speed of the relative movement with respect to the previous frame of the hand images is lower than the second speed threshold value.

10. The method of claim 1, wherein simulating, according to the throwing parameter, the motion trajectory to throw the virtual object, comprises:
establishing, according to the throwing parameter, a physical motion model of the virtual object; and
generating, according to the physical motion model, the motion trajectory of the virtual object.

11. The method of claim 1, wherein the throwing parameter comprises a throwing position, a throwing force and a throwing direction; and
in response to determining that the throwing force belongs to a force interval matching the throwing position, and that the throwing direction belongs to a direction interval matching the throwing position, it is determined that the motion trajectory of the virtual object passes through a throwing destination position.

12. The method of claim 1, before determining the throwing parameter according to the hand images in response to the trigger gesture of throwing the virtual object from the hand images, the method further comprises:
determining an affine transformation relationship of each frame of the hand images with respect to a reference image; and
aligning, according to the affine transformation relationship, each frame of the hand images with the reference image.

13. The method of claim 12, wherein determining the affine transformation relationship of each frame of the hand images with respect to the reference image comprises:
calculating, based on an optical flow method, a coordinate deviation between a corner point of the hand in each frame of the hand images and a corresponding corner point of the reference image; and
according to the coordinate deviation, determining the affine transformation relationship of each frame of the hand images with respect to the reference image.

14. The method of claim 1, wherein before determining the throwing parameter according to the hand images in response to the trigger gesture of throwing the virtual object from the hand images, the method further comprises:
collecting a plurality of frames of the hand images by an image sensor, and performing mean filtering on a plurality of consecutive frames of the hand images according to a set step length.

15. The method of claim 1, further comprising:
rendering the AR scenario to display at least one of the following in the AR scenario:
illumination in the AR scenario and a shadow formed by the virtual object under the illumination;
texture of the virtual object;
a visual special effect of the AR scenario; and
throwing result information of the virtual object.

16. (canceled)

17. An electronic device, comprising:
one or more processors; and
a storage, configured to store one or more programs, wherein,
the one or more programs, when executed by the one or more processors, cause the electronic device to:
recognizing, according to three-dimensional coordinates of a hand key point, a trigger gesture of throwing a virtual object from hand images, wherein the hand images comprise at least two consecutive frames of first hand images in which the hand key point is relatively stationary, at least one frame of a second hand image in which the hand key point moves relative to the first hand images, and a gesture in at least one of the first hand images and the second hand image is the trigger gesture;
in response to the trigger gesture, determining a throwing parameter according to the hand images; and
simulating a motion trajectory to throw the virtual object according to the throwing parameter, and displaying the virtual object in an augmented reality (AR) scenario according to the motion trajectory.

18. A non-transitory computer-readable medium, on which computer-readable instructions are stored, wherein the computer-readable instructions, when executed by a processor of a computer, cause the computer to:
recognizing, according to three-dimensional coordinates of a hand key point, a trigger gesture of throwing a virtual object from hand images, wherein the hand images comprise at least two consecutive frames of first hand images in which the hand key point is relatively stationary, at least one frame of a second hand image in which the hand key point moves relative to the first hand images, and a gesture in at least one of the first hand images and the second hand image is the trigger gesture;
in response to the trigger gesture, determining a throwing parameter according to the hand images; and
simulating a motion trajectory to throw the virtual object according to the throwing parameter, and displaying the virtual object in an augmented reality (AR) scenario according to the motion trajectory.

19. The electronic device of claim 17, wherein recognizing, according to the three-dimensional coordinates of the hand key point, the trigger gesture of throwing the virtual object from the hand images, comprises:
calculating, based on a set angle of field of view, the three-dimensional coordinates of the hand key point in the hand images under a camera coordinate system;
determining, according to a position relationship of the three-dimensional coordinates of the hand key point with respect to a standard pose skeleton template, a pose of the hand in the hand images; and
recognizing, according to the pose of the hand in the hand images, the trigger gesture.

20. The electronic device of claim 17, wherein the hand images comprise at least two consecutive frames of third hand images, and the gesture in the third hand images is throwing gesture;
determining, according to the hand images, the throwing parameter, comprises:
calculating, based on a set angle of field of view, three-dimensional coordinates of a hand key point in each frame of the third hand images under a camera coordinate system; and
determining, according to the three-dimensional coordinates of the hand key point in each frame of the third hand images, the throwing parameter.

21. The non-transitory computer-readable medium of claim 18, wherein recognizing, according to the three-dimensional coordinates of the hand key point, the trigger gesture of throwing the virtual object from the hand images, comprises:
calculating, based on a set angle of field of view, the three-dimensional coordinates of the hand key point in the hand images under a camera coordinate system;
determining, according to a position relationship of the three-dimensional coordinates of the hand key point with respect to a standard pose skeleton template, a pose of the hand in the hand images; and
recognizing, according to the pose of the hand in the hand images, the trigger gesture.
